(19) United States
(12) Patent Application Publication
(10) Pub. No.: US 2025/0285244 A1
(43) Pub. Date: Sep. 11, 2025

(54) DISPLAY CONTROL METHOD, ELECTRONIC DEVICE AND STORAGE MEDIUM

(71) Applicant: Shanghai Tianma Microelectronics Co., Ltd., Shanghai (CN)

(72) Inventors: Xi LI, Shanghai (CN); Bojia LYU, Shanghai (CN); Jinhui HUA, Shanghai (CN)

(21) Appl. No.: 19/212,643

(22) Filed: May 19, 2025

(30) Foreign Application Priority Data
Dec. 31, 2024 (CN) 202411999517.6

(51) Int. Cl. G06T 5/77; G06T 5/20; G06T 7/00

(52) U.S. Cl. CPC G06T 5/77; G06T 5/20; G06T 7/0002; G06T 2207/30168

(57) ABSTRACT

Provided is a display control method, an electronic device and a storage medium. The display control method includes: obtaining an original image; (2) obtaining an initial binary image, where the initial binary image and the original image have the same quantity of pixels; (3) obtaining a function value of an objective function based on the original image and the initial binary image; and (4) adjusting a pixel value of a pixel in the initial binary image once, repeating step (2) and step (3) to minimize the function value until a preset iteration stop condition is met, and using a result output by a latest iteration as a final binary image. Technical solutions of the embodiments of the present disclosure solves the problem of obvious grid texture of single frame images in the processed images in the related art, and improves the quality of the processed single-frame image.

### CROSS-REFERENCE TO RELATED APPLICATION

The present disclosure claims priority to Chinese Patent Application No. 202411999517.6, filed on Dec. 31, 2024, the content of which is incorporated herein by reference in its entirety.

### TECHNICAL FIELD

The present disclosure relates to the field of display control technologies, and in particular, to a display control method, an electronic device, and a storage medium.

### BACKGROUND

Electronic paper cannot display a multi-grayscale video due to its material and driving limitations, and usually can only display a two-grayscale video. To achieve a multi-grayscale display effect with two-grayscale, image processing algorithms are required to process the images. An image processed by the image processing algorithm in the related art has a problem of poor quality, thereby reducing the clarity of a video.

### SUMMARY

The present disclosure provides a display control method, an electronic device and a storage medium, to solve the problem of poor quality of the image processed by the image processing algorithm in the related art.

According to a first aspect of the present disclosure, a display control method is provided, which includes: (1) obtaining an original image; (2) obtaining an initial binary image, where the initial binary image and the original image have the same quantity of pixels, and pixel values of pixels in the initial binary image include a or b, where a and b are not equal; (3) obtaining a function value of an objective function according to the original image and the initial binary image, where the objective function is configured to calculate a difference between the original image and the initial binary image; and (4) adjusting a pixel value of a pixel in the initial binary image once, repeating step (2) and step (3) to minimize the function value until a preset iteration stop condition is met, and using a result output by a latest iteration as a final binary image.

According to a second aspect of the present disclosure, an electronic device is provided, which includes a memory, a processor, and a computer program stored in the memory and executable on the processor. The processor implements a display control method including: (1) obtaining an original image; (2) obtaining an initial binary image, wherein the initial binary image and the original image have the same quantity of pixels, and pixel values of pixels in the initial binary image comprise a or b, wherein a and b are not equal; (3) obtaining a function value of an objective function based on the original image and the initial binary image, wherein the objective function is configured to calculate a difference between the original image and the initial binary image; and (4) adjusting a pixel value of a pixel in the initial binary image once, repeating step (2) and step (3) to minimize the function value until a preset iteration stop condition is met, and using a result output by a latest iteration as a final binary image.

According to a third aspect of the present disclosure, a computer readable storage medium is provided, where a computer program is stored. The program, when executed by a processor, implements a display control method including: (1) obtaining an original image; (2) obtaining an initial binary image, wherein the initial binary image and the original image have the same quantity of pixels, and pixel values of pixels in the initial binary image comprise a or b, wherein a and b are not equal; (3) obtaining a function value of an objective function based on the original image and the initial binary image, wherein the objective function is configured to calculate a difference between the original image and the initial binary image; and (4) adjusting a pixel value of a pixel in the initial binary image once, repeating step (2) and step (3) to minimize the function value until a preset iteration stop condition is met, and using a result output by a latest iteration as a final binary image.

It should be understood that the description in this section is not intended to identify key or important features of embodiments of the present disclosure, nor is it intended to limit the scope of the present disclosure. Other features of the present disclosure will be readily understood from the following description.

### BRIEF DESCRIPTION OF DRAWINGS

In order to describe the technical solutions of the embodiments of the present disclosure more clearly, the accompanying drawings required to be used in the description of the embodiments will be briefly introduced. It is appreciated that, the accompanying drawings described below are merely some embodiments of the present disclosure, and for those skilled in the art, other accompanying drawings can be obtained based on these accompanying drawings without creative effort.

FIG. 1 is a flowchart of a first display control method according to an embodiment of the present disclosure;

FIG. 2 is a schematic diagram of an original image according to an embodiment of the present disclosure;

FIG. 3 is a schematic diagram of a first initial binary image according to an embodiment of the present disclosure;

FIG. 4 is a schematic diagram of a second initial binary image according to an embodiment of the present disclosure;

FIG. 5 is a schematic diagram of a third initial binary image according to an embodiment of the present disclosure;

FIG. 6 is a schematic diagram of a fourth initial binary image according to an embodiment of the present disclosure;

FIG. 7 is a flowchart of a second display control method according to an embodiment of the present disclosure;

FIG. 8 is a flowchart of a third display control method according to an embodiment of the present disclosure;

FIG. 9 is a flowchart of a fourth display control method according to an embodiment of the present disclosure;

FIG. 10 is a schematic diagram of a fifth initial binary image according to an embodiment of the present disclosure;

FIG. 11 is a schematic diagram of a sixth initial binary image according to an embodiment of the present disclosure;

FIG. 12 is a flowchart of a fifth display control method according to an embodiment of the present disclosure;

FIG. 13 is a flowchart of a sixth display control method according to an embodiment of the present disclosure;

FIG. 14 is a schematic diagram of a seventh initial binary image according to an embodiment of the present disclosure;

FIG. 15 is a flowchart of a seventh display control method according to an embodiment of the present disclosure;

FIG. 16 is a flowchart of an eighth display control method according to an embodiment of the present disclosure;

FIG. 17 is a flowchart of a ninth display control method according to an embodiment of the present disclosure;

FIG. 18 is a flowchart of a tenth display control method according to an embodiment of the present disclosure;

FIG. 19 is a flowchart of an eleventh display control method according to an embodiment of the present disclosure;

FIG. 20 is a flowchart of a twelfth display control method according to an embodiment of the present disclosure; and

FIG. 21 is a structural schematic diagram of an electronic device applied to a display control method according to an embodiment of the present disclosure.

### DESCRIPTION OF EMBODIMENTS

In order to make those skilled in the art better understand the solutions of the present disclosure, technical solutions in embodiments of the present disclosure will be described clearly and completely below in connection with the drawings in the present disclosure. It is appreciated that, the described embodiments are only a part of the embodiments of the present disclosure, not all of them. All other embodiments obtained by those skilled in the art without any creative effort based on the embodiments of the present disclosure shall fall into the protection scope of the present disclosure.

It should be noted that the terms “first”, “second” and the like in the specification, claims and drawings of the present disclosure are configured to distinguish similar objects, and are not necessarily configured to describe a specific order or sequence. It should be understood that the data used in this way may be interchanged under appropriate circumstances, so that the embodiments of the present disclosure described herein can be implemented in order other than those illustrated or described herein. Furthermore, the terms “include” and “have” and any variations thereof are intended to cover non-exclusive inclusion, e.g., processes, methods, systems, products or devices that include a series of steps or units are not necessarily limited to those steps or units that are expressly listed, but may include other steps or units not expressly listed or inherent to such processes, methods, products or devices.

A common image processing algorithm in the related art includes a Bayer matrix ordered dithering algorithm. The video processed by the Bayer matrix ordered dithering algorithm does not have visual dither during frame switching, but the grid texture of a single-frame image is obvious, resulting in low video clarity.

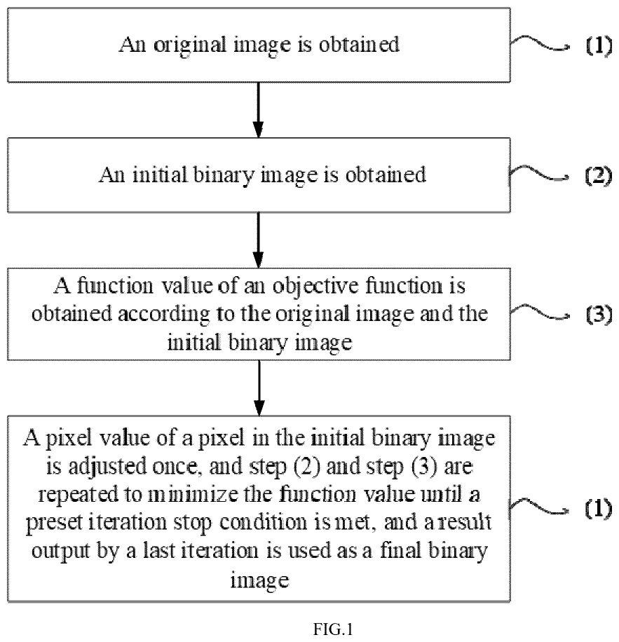

FIG. 1 is a flowchart of a first display control method according to an embodiment of the present disclosure. As shown in FIG. 1, the display control method includes the following steps.

(1) An original image is obtained.

The original image may be an image of each frame after the to-be-processed video is decomposed into frames. An original image of each frame may be obtained after the to-be-processed video is decomposed into frames. In the embodiments of the present disclosure, since the content to be processed is images in a certain frame or multiple frames of the video to be processed, the processing of the original images has a sequence, that is, the processing of the original image of the first frame is first performed, and the processing of the original image of the second frame is performed after the processing of the original image of the first frame is completed, and so on until the processing of the original images of all decomposed frames from the video to be processed is completed, that is, the original image of each frame in the video to be processed is processed into a halftone image, and then the processed video is output.

(2) An initial binary image is obtained. The initial binary image and the original image have a same quantity of pixels, and pixel values of pixels in the initial binary image include a or b, where a and b are not equal.

The number of pixels in the initial binary image is the same as the number of pixels in the original image, and the arrangement of the pixels in the initial binary image is the same as the arrangement of the pixels in the original image. For example, the initial binary image includes pixels of i rows and j columns, and the original image also includes pixels of i rows and j columns, where i and j are positive integers greater than 1. In an embodiment, the pixel value of each pixel in the initial binary image is a or b. In another embodiment, pixel values of some pixels in the initial binary image are a, and pixel values of other pixels are b. Exemplarily, a=0, b=1; or a=1, b=0. The pixel values a and b in the initial binary image may also be assigned other values, for example, a=0, b=255; or a=255, b=0.

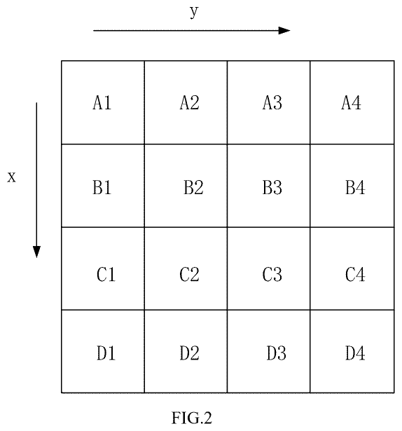

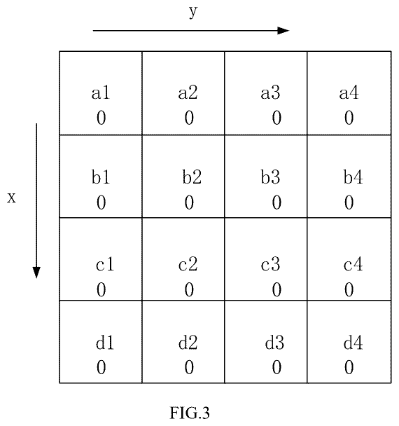

FIG. 2 is a schematic diagram of an original image according to an embodiment of the present disclosure. FIG. 3 is a schematic diagram of a first initial binary image according to an embodiment of the present disclosure. With reference to FIG. 2 and FIG. 3, when the original image has a resolution of 4*4, a selected initial binary image can be an image with a resolution of 4*4 and each pixel therein having a pixel value of 0. It should be noted that the pixel arrangement of 4 rows and 4 columns shown in FIG. 2 and FIG. 3 is merely an example, and it is not a limitation on the number of pixels and the pixel arrangement.

(3) A function value of an objective function is obtained according to the original image and the initial binary image. The objective function is configured to calculate a difference between the original image and the initial binary image.

Parameters such as pixel values of the original image and the initial binary image are substituted into the objective function, a difference between the original image and the initial binary image may be calculated through the objective function, and the function value may represent the difference. The larger the function value, the greater the difference, and the greater the difference between the original image and the initial binary image. The smaller the function value, the smaller the difference, and the smaller the difference between the original image and the initial binary image.

(4) Pixel values of pixels in the initial binary image are adjusted once, and step (2) and step (3) are repeated to minimize the function value until a preset iteration stop condition is met, and a result output by a latest iteration is used as a final binary image.

The pixel values of the pixels in the initial binary image are adjusted once, and the pixel value of at least one pixel in the initial binary image is changed. For example, a pixel value of one pixel in the initial binary image is changed from 0 to 1 or from 1 to 0. In some embodiments, pixel values of multiple pixels may also be changed simultaneously. Alternatively, pixel values of at least two pixels are swapped.

Exemplarily, each pixel may be sequentially adjusted, with only one pixel adjusted at a time. For example, it may be a change of the pixel value of the pixel, or a swap between the pixel value of the pixel and the pixel value of its neighboring pixel. The function value of the objective function is obtained again according to the initial binary image and the original image after being adjusted once.

Exemplarily, if the current iteration is set to the n-th cycle, a function value in the n-th iteration is compared with a function value in a (n−1)-th iteration, an initial binary image corresponding to the minimum function value is taken as an adjustment target for the n-th iteration, the adjusted initial binary image is applied to the step (2) of the (n+1)-th iteration, and the iteration is repeated continuously until the minimum function value is obtained.

Exemplarily, the preset iteration stop condition may be that all pixels in the initial binary image are fully adjusted according to a pixel value adjustment manner of the pixels in the preset initial binary image. When the preset iteration stop condition is met, a result output by the latest iteration is configured as a final binary image, and the final binary image may be an initial binary image corresponding to the minimum function value in all iterations, that is, only the final binary image has the minimum difference from the original image in all iterations. The iteration refers to taking a result of a current output as a next input value.

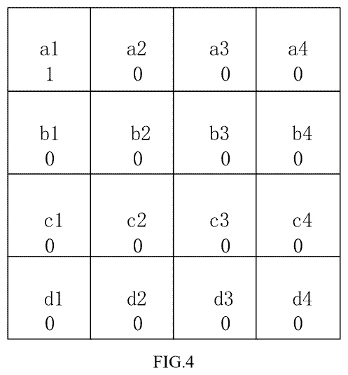

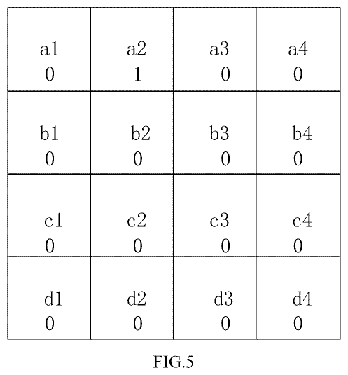

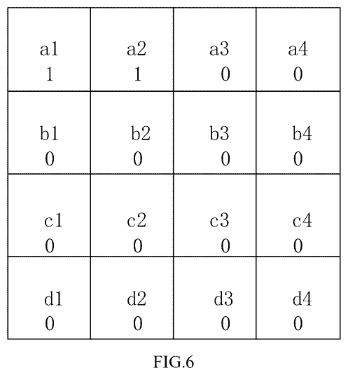

For example, with continued reference to FIG. 2 and FIG. 3, (1) an original image is obtained. The original image may be an image with a resolution of 4*4 shown in FIG. 2, and each pixel in the original image should be numbered. The 16 pixels are A1, A2, A3, A4, B1, B2, B3, B4, C1, C2, C3, C4, D1, D2, D3, and D4, respectively. (2) An initial binary image is obtained. The initial binary image may be an image with a resolution of 4*4 shown in FIG. 3, pixel values in the initial binary image are all 0, and each pixel in the initial binary image should be numbered. The 16 pixels are a1, a2, a3, a4, b1, b2, b3, b4, c1, c2, c3, c4, d1, d2, d3, and d4, respectively. (3) The function value f1 of the objective function in the first iteration is obtained according to the original image and the initial binary image. (4) The pixel value of the pixel in the initial binary image is adjusted once. FIG. 4 is a schematic diagram of a second initial binary image according to an embodiment of the present disclosure. As shown in FIG. 4, a pixel value of a pixel a1 is changed from 0 to 1 and continues to serve as the initial binary image of step (2) to start a second iteration. (3) The function value f2 of the objective function in the second iteration is obtained according to the original image and the initial binary image. f2 is compared with f1, and if f2≥f1, the next adjustment is performed to change the pixel value of pixel a2 from 0 to 1 based on the pixel values of pixels in the initial binary image corresponding to f1. FIG. 5 is a schematic diagram of a third initial binary image according to an embodiment of the present disclosure, and the initial binary image after the second iteration adjustment is changed from FIG. 3 to FIG. 5. If f2<f1, the next adjustment is performed to change the pixel value of pixel a2 from 0 to 1 based on the pixel values of the pixels in the initial binary image corresponding to f2. FIG. 6 is a schematic diagram of a fourth initial binary image according to an embodiment of the present disclosure, and the initial binary image after the second iteration adjustment is changed from FIG. 4 to FIG. 6. The adjusted initial binary image continues to be configured as the initial binary image of step (2) in the third iteration. (3) The function value f3 of the objective function in the third iteration is obtained according to the original image and the initial binary image. If f2>f1 in the second iteration, f3 is compared with f1 in the third iteration. If f2<f1 in the second iteration, f3 is compared with f2 in the third iteration, and subsequently, based on the comparison result, it is determined to adjust the initial binary image corresponding to the minimum function value thereof. By analogy, until the initial binary images in all iterations are adjusted to meet the preset iteration stop condition, the result output by the latest iteration is configured as the final binary image. The function value of the objective function of the final binary image and the original image is the minimum function value in all iterations, and the final binary image has the minimum difference from the original image and is the halftone image.

It may be understood that steps (1), (2), (3), and (4) are steps of processing the original image of one frame. Because the to-be-processed video includes original images of multiple frames, an original image of the next frame needs to be continuously obtained after a final binary image corresponding to the original image of one frame is output.

In the technical solutions of embodiments of the present disclosure, a pixel value of a pixel in the initial binary image is adjusted, the difference between the original image and the initial binary image is calculated after each adjustment, and finally the final binary image with the minimum difference from the original image is obtained. Each frame of the to-be-processed video processed by the display control method in the embodiments of the present disclosure outputs a final binary image with the minimum difference from the original image, thereby obtaining a high-quality halftone video. The problem that the grid texture is obvious caused by the orderliness of the dither matrix is solved, thereby improving the image quality after being single-frame image processing.

In the technical solutions of the embodiments of the present disclosure, the original image of the to-be-processed video is obtained, the initial binary image corresponding to the number of pixels of the original image is obtained. The function value of the objective function is calculated according to the original image and the initial binary image, and the pixel values of the pixels in the initial binary image are continuously and circularly adjusted to minimize the function value, so that the final binary image with the minimum difference from the original image is obtained and output, thereby solving the problem of the obvious grid texture of a single-frame image in the processed images in the related art, and thus improving the image quality of a single-frame image after processing.

In an embodiment, the objective function ƒ includes ƒ₁, which is used to calculate [symbol] l similarity between the original image and the initial binary image. By substituting the parameters in the original image and the initial binary image into ƒ₁, the structural similarity between the original image and the initial binary image can be calculated. In the embodiments of the present disclosure, for a single-frame image, the function of structural similarity is added into an algorithm of the objective function, thereby improving the quality of the single-frame image.

In some embodiments, ƒ₁ satisfies:

$$\frac{{}_{G} {μ}_{H} + {C}_{1} ) ( 2 {σ}_{GH} + {C}_{2} )}{⊢ {{μ}_{H}}^{2} + {C}_{1} ) ( {σ}_{G} + {σ}_{H} + {C}_{2} )} .$$

μ_{G} is a mean value of the original image, μ_{H} is a mean value of the initial binary [symbol] is a variance of the original image, σ_{H} is a variance of the initial binary image, and σ_{GH} is a covariance between the original image and the initial binary image.

C₁=(K₁L)².

C₂=(K₂L)².

K₁ and K₂ are constants not exceeding 0.1, and L is an image grayscale dynamic [symbol] image grayscale dynamic range L may be selected as 255. A value of ƒ₁ may be calculated by substituting the mean value μ_{G} of the original image, the mean value μ_{H} of the initial binary image, the variance σ_{G} of the original image, the variance σ_{H} of the initial binary image, the covariance σ_{GH} of the original image and the initial binary image, and C₁ and C₂ into the formula of ƒ₁.

Values of K₁ and K₂ may be selected according to image processing quality in [symbol] tual operation. In some embodiments, K₁ is 0.01 and K₂ is 0.02.

In an embodiment, the structural similarity between the original image and the initial [symbol] ge may be calculated through the calculation of ƒ₁. ƒ₁ ranges from 0 to 1, the smaller ƒ1, the more similar the original image and the initial binary image.

It may be understood that, in embodiments of the present disclosure, ƒ₁ is introduced [symbol] ojective function, so that a function value of the objective function ƒ can, to some extent, represent the structural similarity between the original image and the initial binary image. By calculating the structural similarity between the original image and the initial binary image in each iteration, the initial binary image with the highest similarity to the original image can be determined, further the relationship between the original image and the initial binary image is established. In the process of minimizing the function value, the visual effect of the initial binary image can be optimized towards the original image, so that the initial binary image is closer to the original image until the final binary image with the minimum difference from the original image is obtained, thereby improving the image processing quality.

In the technical solutions of the embodiments of the present disclosure, the function [symbol] tural similarity calculation is set in the objective function ƒ, so that the structural similarity between the original image and the initial binary image needs to be calculated when the function value is minimized, and the final binary image with the minimum difference from the original image can be obtained through the calculation of the structural similarity, thereby improving the image quality of the single-frame image after processing.

In an embodiment, ƒ satisfies: ƒ=γƒ₁+(1−γ)ƒ₂.

ƒ₂ is configured to calculate an error between the original image and the initial [symbol] ge, γ is a constant greater than or equal to 0 and less than or equal to 1.

ƒ₂ is configured to calculate an error between the original image and the initial [symbol] ge, ƒ₁ is configured to calculate the structural similarity between the original image and the initial binary image, f is a sum of a certain proportion of ƒ₂ and a certain proportion of ƒ₁, and a difference between the original image and the initial binary image is obtained by comprehensively calculating an error between the original image and the initial binary image and a structural similarity between the original image and the initial binary image through the objective function ƒ.

A value of γ in the objective function is a constant greater than or equal to 0 and less [symbol] ual to 1. The value of γ can be selected based on the obtained image quality in practical operations. In some embodiments, in order to improve image processing efficiency and optimize algorithms, γ can be set to 0 when processing the original image of the first frame and set to a constant other than 0 when processing the original images of subsequent frames. It is verified that this method does not affect the algorithm processing results and can improve the algorithm processing efficiency.

In some embodiments, ƒ₂ satisfies: [symbol] x,y)−H(x,y)|².

G(x,y) is a pixel value of the pixel at the row x and column y in the original image, [symbol] a pixel value of the pixel at the row x and column y in the initial binary image.

The error between the original image and the initial binary image may be obtained by calculating a sum of squares of differences between pixel values of the original image and pixel values of the initial binary image. In some embodiments, the pixel value includes a grayscale value. The grayscale value may be a value for measuring brightness changes between [symbol] st and darkest, typically ranging from 0 to 255, with white being 255 and black being [symbol] ining the grayscale value of each pixel in the original image, the pixel value of each pixel can be obtained, and then the error ƒ₂ between the original image and the initial binary image can be calculated.

In an embodiment, with continued reference to FIG. 2 and FIG. 3, the x-direction [symbol] n arrangement direction of pixel rows, and the y-direction indicates an arrangement direction of pixel columns. The pixel row includes a plurality of pixels arranged along the y-direction, and the pixel column includes a plurality of pixels arranged along the x-direction. A1 corresponds to G(1,1), A2 corresponds to G(1,2), . . . , D4 corresponds to G(4,4); a1 corresponds to H(1,1), a2 corresponds to H(1,2), . . . , d4 corresponds to H(4,4). A sum of squares of differences between the original image and the initial binary image at the same coordinates is calculated separately to obtain ƒ₂, which is the error between the original image and the initial binary image.

It can be understood that, in the embodiments of the present disclosure, the structural [symbol] between the original image and the initial binary image is calculated by setting f₁ in the objective function, and the error between the original image and the initial binary image is calculated by ƒ₂, the relationship between the original image and the initial binary image is further established, so that the function value corresponding to the objective function f can more accurately characterize the difference between the original image and the initial binary image, and the initial binary image obtained by minimizing the function value of the objective function is closer to the original image, thereby improving the image processing quality.

In the technical solutions of the embodiments of the present disclosure, by [symbol] g an objective function ƒ=γƒ₁+(1−γ)ƒ₂, calculating the error between the original image and the initial binary image through ƒ₂, and calculating the structural similarity between the original image and the initial binary image through ƒ₁, so that the difference between the original image and the initial binary image can be obtained through the objective function ƒ by calculating the error between the original image and the initial binary image and the structural similarity between the original image and the initial binary image, so that the final binary image with the minimum function value can be closer to the original image, thereby improving the image processing quality.

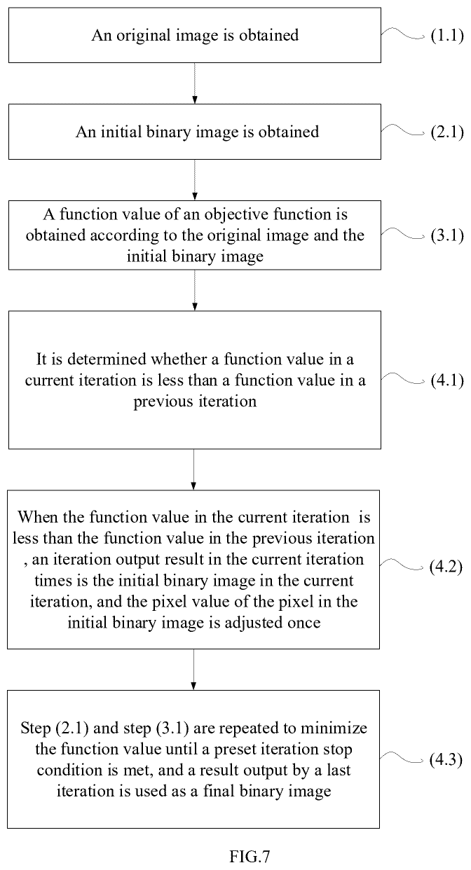

According to the above embodiments, FIG. 7 is a flowchart of a second display control method according to an embodiment of the present disclosure. As shown in FIG. 7, the display control method includes the following steps.

(1.1) An original image is obtained.

(2.1) An initial binary image is obtained. The initial binary image and the original image have the same quantity of pixels, and pixel values of pixels in the initial binary image include a or b, where a and b are not equal.

(3.1) A function value of an objective function is obtained according to the original image and the initial binary image. The objective function is configured to calculate a difference between the original image and the initial binary image.

(4.1) It is determined whether a function value in a current iteration is less than a function value in a previous iteration.

The current iteration may be the current cycle, and may specifically be the cycle times of step (2.1) and step (3.1). For example, when the current cycle is the n-th one, the number of iterations is also n, and the current function value is an obtained n-th function value.

Determining whether the function value in the current iteration is less than the function value in the previous iteration may be determining whether the function value in the n-th cycle is less than the function value in the (n−1)-th cycle.

(4.2) When the function value in the current iteration is less than the function value in the previous iteration, an iteration output result in the current iteration is the initial binary image in the current iteration, and a pixel value of a pixel in the initial binary image is adjusted once.

When the function value in the current iteration is less than the function value in the previous iteration, it means that the difference between the initial binary image corresponding to the function value in the n-th cycle and the original image is smaller than the difference between the initial binary image corresponding to the function value in the (n−1)-th cycle and the original image. Therefore, in the n-th cycle, the output result is an initial binary image corresponding to the function value in the n-th cycle, that is, in the current iteration, the iteration output result is the initial binary image in the current iteration.

After the initial binary image in the current iteration is output, further adjustment to it is continued. That is, the initial binary image corresponding to the function value in the n-th cycle is adjusted to change its pixel value.

In an embodiment, it may be understood that when the function value in the current iteration is less than the function value in the previous iteration, the initial binary image in the current iteration is configured as the basis for the next pixel-value adjustment, and the pixel value of the pixel in the initial binary image is adjusted once, so that the initial binary image adjusted in each cycle is the initial binary image with the minimum difference from the original image in all cycles at present, thereby achieving the purpose of minimizing the function value.

(4.3) Step (2.1) and step (3.1) are repeated to minimize the function value until a preset iteration stop condition is met, and a result output by a latest iteration is used as a final binary image.

Exemplarily, with continued reference to FIG. 2, FIG. 3, and FIG. 4, if the current cycle is set to be the 2nd one, the number of iterations is also set to be 2. FIG. 4 is set as an initial binary image corresponding to the 2nd cycle, and FIG. 3 is set as an initial binary image corresponding to the 1st cycle. (4.1) It is determined whether a function value in a current iteration is less than a function value in a previous iteration, that is, it is determined whether the function value f2 corresponding to FIG. 4 in the second cycle is less than the function value f1 corresponding to FIG. 3 in the first cycle. (4.2) When the function value in the current iteration is less than the function value in the previous iteration, an iteration output result in the current iteration is the initial binary image in the current iteration, and the pixel value of the pixel in the initial binary image is adjusted once. That is, when f2<f1, the pixel value of the pixel in the initial binary image corresponding to f2 is adjusted once to change the pixel value of pixel a2 from 0 to 1. With continued reference to FIG. 6, and the initial binary image after the second cycle adjustment is changed from FIG. 4 to FIG. 6. It may be understood that the adjustment manner and sequence in the initial binary image may be preset, and changing the pixel value of the pixel a2 from 0 to 1 is an exemplary representation of an adjustment manner.

In some embodiments, the preset iteration stop condition includes that the function value reaches a convergence value. The convergence value can be reached when the function value of the objective function reaches its minimum, and at this time, iterative calculations are continued and the function value obtained remains unchanged after comparison. When the preset iteration stop condition is met, that is, the function value reaches the convergence value, it is considered that the minimum function value is obtained, and the difference between the final binary image corresponding to the convergence value and the original image is minimum.

In the technical solutions of the embodiments of the present disclosure, the function value in the current iteration is compared with the function value in the previous iteration, and when the function value in the current iteration is smaller than the function value in the previous iteration, the initial binary image in the current iteration is configured as the adjustment target, so that the function value corresponding to the initial binary image adjusted each time is the minimum function value in all cycles at present, achieving the purpose of minimizing the function value, and ensuring that the initial binary image is closer to the original image more and more along with the increase of the number of iterations.

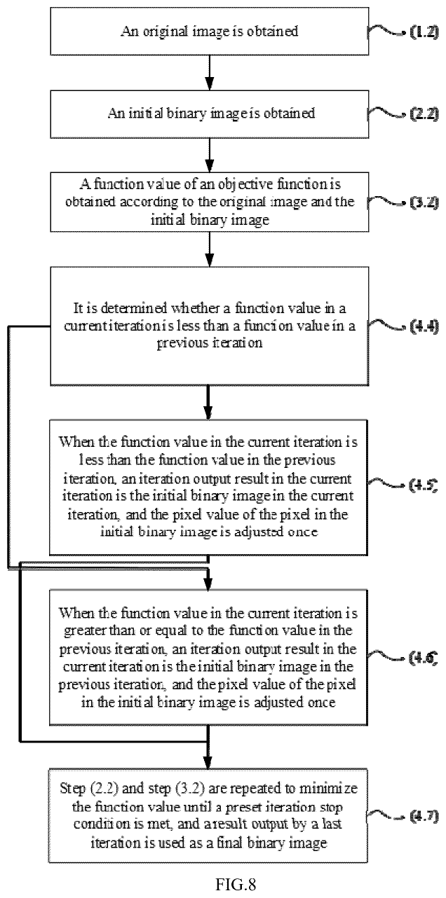

According to the above embodiments, FIG. 8 is a flowchart of a third display control method according to an embodiment of the present disclosure. As shown in FIG. 8, the display control method includes the following steps.

(1.2) An original image is obtained.

(2.2) An initial binary image is obtained. The initial binary image and the original image have the same quantity of pixels, and pixel values of pixels in the initial binary image include a or b, where a and b are not equal.

(3.2) A function value of an objective function is obtained according to the original image and the initial binary image. The objective function is configured to calculate a difference between the original image and the initial binary image.

(4.4) It is determined whether a function value in a current iteration is less than a function value in a previous iteration.

(4.5) When the function value in the current iteration is less than the function value in the previous iteration, an iteration output result in the current iteration is the initial binary image in the current iteration, and the pixel value of the pixel in the initial binary image is adjusted once.

(4.6) When the function value in the current iteration is greater than or equal to the function value in the previous iteration, an iteration output result in the current iteration is the initial binary image in the previous iteration, and the pixel value of the pixel in the initial binary image is adjusted once.

When the function value in the current iteration is greater than or equal to the function value in the previous iteration, it means that the difference between the initial binary image corresponding to the function value in the n-th cycle and the original image is greater than or equal to the difference between the initial binary image corresponding to the function value in the (n−1)-th cycle and the original image. Therefore, in the n-th current cycle, the output result is an initial binary image corresponding to the function value in the (n−1)-th cycle, that is, in the current iterations, an iteration output result is the initial binary image in the previous iteration, ensuring that the difference between the initial binary image and the original image becomes smaller and smaller.

After the initial binary image in the previous iteration is output, further adjustment to it is continued, that is, the initial binary image corresponding to the function value in the (n−1)-th cycle is adjusted to change its pixel value.

In an embodiment, it may be understood that when the function value in the current iteration is greater than or equal to the function value in the previous iteration, the initial binary image in the previous iteration is configured as the basis for the next pixel-value adjustment, and the pixel value of the pixel in the initial binary image is adjusted once, so that the initial binary image adjusted in each cycle is the initial binary image with the minimum difference from the original image in all cycles at present, thereby achieving the purpose of minimizing the function value.

(4.7) Step (2.2) and step (3.2) are repeated to minimize the function value until a preset iteration stop condition is met, and a result output by a latest iteration is used as a final binary image.

Exemplarily, with continued reference to FIG. 2, FIG. 3, and FIG. 4, if the current cycle is set to be the 2nd one, the number of iterations is also set to be 2. FIG. 4 is set as an initial binary image corresponding to the 2nd cycle, and FIG. 3 is set as an initial binary image corresponding to the 1st cycle. (4.1) It is determined whether a function value in a current iteration is less than a function value in a previous iteration, that is, it is determined whether the function value f2 corresponding to FIG. 4 in the second cycle is less than the function value f1 corresponding to FIG. 3 in the first cycle. (4.2) When the function value in the current iteration is greater than or equal to the function value in the previous iteration, an iteration output result in the current iteration is the initial binary image in the previous iteration, and the pixel value of the pixel in the initial binary image is adjusted once. That is, when f2≥f1, the pixel value of the pixel in the initial binary image corresponding to f1 is adjusted once to change the pixel values of pixel a2 from 0 to 1. With continued reference to FIG. 1, and the initial binary image after the second cycle adjustment is changed from FIG. 3 to FIG. 5.

In the technical solutions of the embodiments of the present disclosure, the function value in the current iteration is compared with the function value in the previous iteration, and when the function value in the current iteration is greater than or equal to the function value in the previous iteration, the initial binary image in the previous iteration is configured as the adjustment target, so that the function value corresponding to the initial binary image adjusted each time is the minimum function value in all cycles at present, achieving the purpose of minimizing the function value, and ensuring that the initial binary image is closer to the original image more and more along with the increase of the number of iterations.

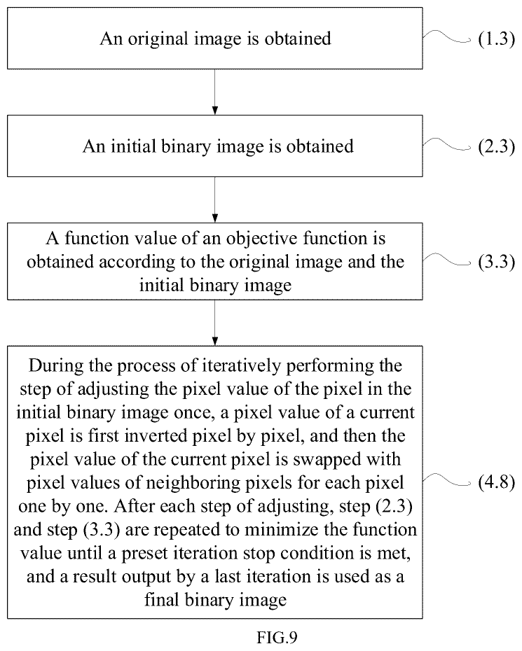

According to the above embodiments, FIG. 9 is a flowchart of a fourth display control method according to an embodiment of the present disclosure. As shown in FIG. 9, the display control method includes the following steps.

(1.3) An original image is obtained.

(2.3) An initial binary image is obtained. The initial binary image and the original image have the same quantity of pixels, and pixel values of pixels in the initial binary image include a or b, where a and b are not equal.

(3.3) A function value of an objective function is obtained according to the original image and the initial binary image. The objective function is configured to calculate a difference between the original image and the initial binary image.

(4.8) In the process of iteratively performing the step of adjusting the pixel value of the pixel in the initial binary image once, the pixel value of the current pixel is first inverted for each pixel one by one, and then the pixel value of the current pixel is swapped with the pixel value of its neighboring pixel one by one for each pixel. After each step of adjusting, step (2.3) and step (3.3) are repeated to minimize the function value until a preset iteration stop condition is met, and a result output by a latest iteration is used as a final binary image.

The iteratively adjusting the pixel value of the pixel in the initial binary image once may refer to adjusting the pixel value of the pixel in the initial binary image once in each cycle of multiple cycles. In multiple adjustments to the pixel values in the initial binary image, the pixel value of the current pixel is first inverted for each pixel one by one, and then the pixel value of the current pixel is swapped with the pixel value of its neighboring pixel for each pixel one by one after the pixel values of multiple pixels are inverted and iterated. The current pixel refers to a pixel to be adjusted in a current cycle (also known as a current cycle process, or known as a current iteration period).

The pixel value of the current pixel is first inverted one by one for each pixel, which may be changing the pixel value of one pixel in each cycle in sequence, and changing the pixel value for each pixel one by one. For example, the pixel value of the corresponding pixel is changed from 0 to 1 or from 1 to 0. For example, with continued reference to FIG. 2 and FIG. 3, in the first iteration, when the number of iterations (that is, the cycle times) is 1, the pixel a1 in the initial binary image is changed from 0 to 1, that is, the adjustment of the pixel value of the initial binary image in the current iteration is completed. In the subsequent iterations, each pixel may be sequentially adjusted according to the sequence of a2, a3, a4, b1, b2, b3, b4, c1, c2, c3, c4, d1, d2, d3, and d4, so as to implement pixel value inversion for each pixel one by one.

The neighboring pixel may refer to all pixels adjacent to the current pixel. For example, if the current pixel is a1, its neighboring pixels are a2, b2 and b1. If the current pixel is b2, its neighboring pixels are a1, a2, a3, b1, b3, c1, c2 and c3. The swap between the pixel value of the current pixel and the pixel value of its neighboring pixel is performed for each pixel one by one, which may be to select the current pixel one by one first. In one adjustment, the pixel value of the current pixel is swapped with the pixel value of its neighboring pixel once. That is, after the multiple swaps between the current pixel and its neighboring pixels are performed for the current pixel to complete the pixel value swap between the current pixel and its neighboring pixels, the pixel value swap between the next pixel and its neighboring pixels is performed. One adjustment is made per cycle. The swap process of the current pixel and its neighboring pixels may be completed through multiple adjustments, that is, the swap process of the current pixel and its neighboring pixels may be completed through multiple cycles.

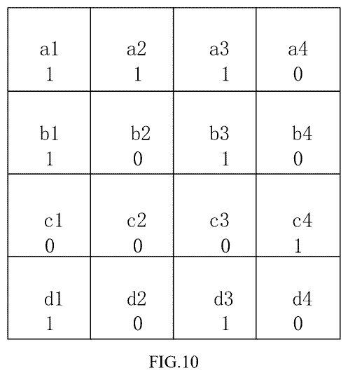

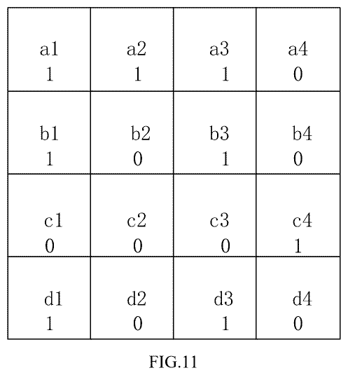

For example, FIG. 10 is a schematic diagram of a fifth initial binary image according to an embodiment of the present disclosure. FIG. 10 shows an initial binary image after pixel value inversion is performed for each pixel one by one, that is, after pixel values of a1 to d4 have all been inverted, and the swap between the pixel value of the current pixel and pixel values of its neighboring pixel is continued. The current pixel is set as a1, and the pixel value of a1 is swapped with a2 in the current iteration. FIG. 11 is a schematic diagram of a sixth initial binary image according to an embodiment of the present disclosure. FIG. 11 shows the initial binary image after the pixel value of a1 is swapped with a2, that is, the adjustment of the pixel value of the initial binary image in the current iteration is completed. The pixel value of a1 may be swapped with b2 and b1 in sequence in the subsequent cycles, so that the pixel value swap between a1 and its neighboring pixels is completed, and the pixel value swap between a pixel among those from a2 to d4 and its neighboring pixels of may be continued after the pixel value swap between a1 and the neighboring pixel is completed.

It may be understood that, after the initial binary image in the n-th iteration at present is adjusted (the adjustment means that the pixel value of the current pixel is reversed or the pixel value of the current pixel is swapped with the pixel value of its neighboring pixel), the cycle adjustment of the (n+1)-th iteration is continued, the function value corresponding to the initial binary image adjusted in the n-th iteration is compared with the function value corresponding to the initial binary image before the adjustment, and the initial binary image corresponding to the minimum function value is selected as the adjustment target in the (n+1)-th iteration. For example, FIG. 3 is an initial binary image in the 1st iteration, and the pixel a1 in the current initial binary image is inverted from 0 to 1, that is, it is changed to the initial binary image shown in FIG. 4, then the 2nd iteration is continued. A function value corresponding to the initial binary image in FIG. 3 is compared with a function value corresponding to the initial binary image in FIG. 4, when the function value corresponding to the initial binary image in FIG. 4 is relatively small, the pixel value of the pixel a2 is inverted by using the initial binary image in FIG. 4 as an adjustment target, to obtain the initial binary image shown in FIG. 6, when the function value corresponding to the initial binary image in FIG. 3 is relatively small, the pixel value of the pixel a2 is inverted by using the initial binary image in FIG. 3 as an adjustment target, to obtain the initial binary image shown in FIG. 5.

It may be understood that, in embodiments of the present disclosure, the reason why the pixel value of the current pixel is first reversed for each pixel one by one and then the pixel value swap between the current pixel and its neighboring pixels is performed for each pixel one by one is as follows: since the adjustment mode of the neighborhood swap may change the pixel values of two pixels at a time, if the pixel value inversion and the pixel value swap of the neighboring pixel are performed alternately, the pixel value of a certain pixel may be repeatedly changed, and then its function value is repeatedly changed, the effect of the pixel value inversion on the minimization of the function value is greater than the effect of the pixel value swap of the neighboring pixel on the minimization of the function value, which increases the amount of computation in the display control method. The pixel value inversion of the current pixel is firstly carried out pixel by pixel to sequentially determine the pixel value with the minimum position difference from the original image for each pixel, and then neighborhood swap is carried out pixel by pixel to improve the computational speed and ensure the efficiency of the display control method.

In the technical solutions of the embodiments of the present disclosure, during the process of iteratively performing the step of adjusting the pixel value of the pixel in the initial binary image, pixel value of current pixel is first inverted pixel by pixel, and then the pixel value swap between the current pixel and its neighboring pixels for each pixel one by one, thereby improving the computational speed of the display control method and thus ensuring the computational efficiency.

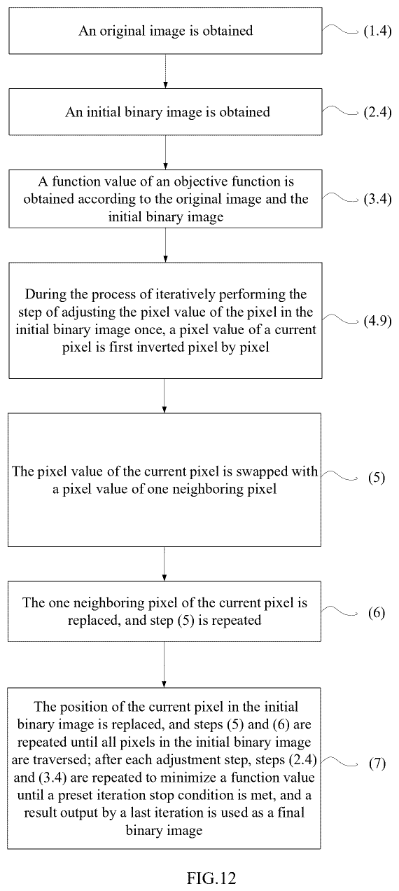

According to the above embodiments, FIG. 12 is a flowchart of a fifth display control method according to an embodiment of the present disclosure. As shown in FIG. 12, the display control method includes the following steps.

(1.4) An original image is obtained.

(2.4) An initial binary image is obtained. The initial binary image and the original image have the same quantity of pixels, and pixel values of pixels in the initial binary image include a or b, where a and b are not equal.

(3.4) A function value of an objective function is obtained according to the original image and the initial binary image. The objective function is configured to calculate a difference between the original image and the initial binary image.

(4.9) In the process of iteratively performing the step of adjusting the pixel value of the pixel in the initial binary image once, the pixel value of the current pixel is first inverted pixel by pixel.

(5) The pixel value of the current pixel is swapped with a pixel value of one of its neighboring pixels.

Since the neighboring pixel may refer to all pixels adjacent to the current pixel, the pixel value of the current pixel is swapped first with a pixel value of one of its neighboring pixels. For example, the current pixel is a1, and the pixel value of a1 is swapped with the pixel value of its neighboring pixel a2.

(6) The neighboring pixel of the current pixel is replaced, and step (5) is repeated.

After the pixel value of the current pixel is swapped with the pixel value of one of its neighboring pixels, the pixel value of the current pixel is swapped with the pixel value of other neighboring pixels sequentially until all neighboring pixels of the current pixel are traversed.

(7) The position of the current pixel in the initial binary image is replaced, and steps (5) and (6) are repeated until all pixels in the initial binary image are traversed. After each adjustment step, steps (2.4) and (3.4) are repeated to minimize a function value until a preset iteration stop condition is met, and a result output by a latest iteration is used as a final binary image.

After the current pixel is swapped with all the neighboring pixels thereof, the pixel is replaced, and then the replaced pixel is swapped with all the neighboring pixels thereof until all the pixels in the initial binary image are traversed.

Exemplarily, with continued reference to FIG. 10, FIG. 10 is set to be an initial binary image after pixel value inversion is performed pixel by pixel, that is, pixel values of a1 to d4 are all inverted, and the pixel value swap between the current pixel and its neighboring pixels is continued. The current pixel is set as a1, and the pixel value of a1 is swapped with a2 in the current iteration. FIG. 11 shows the initial binary image after the pixel value of a1 is swapped with a2, that is, the adjustment of the pixel value of the initial binary image in the current iteration is completed. The pixel value of a1 may be swapped with b2 and b1 in sequence in the subsequent cycles, so that the pixel value swap between a1 and its neighboring pixels is completed, and the pixel value swap between a pixel from a2 to d4 and its neighboring pixels is continued after the pixel value swap between a1 and its neighboring pixels is completed.

In the technical solutions of the embodiments of the present disclosure, the pixel value of the pixel is continuously swapped with the pixel values of its neighboring pixels after the pixel value of the pixel are inverted pixel by pixel, thereby ensuring the operation efficiency, and meanwhile, minimizing the function value.

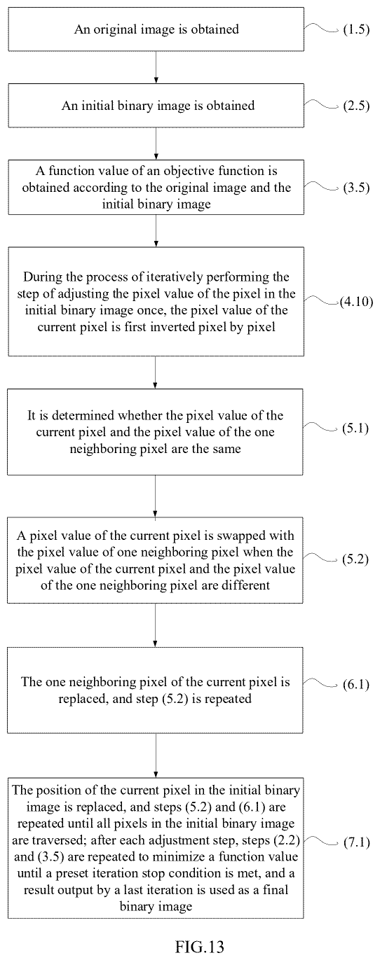

According to the above embodiments, FIG. 13 is a flowchart of a sixth display control method according to an embodiment of the present disclosure. As shown in FIG. 13, the display control method includes the following steps.

(1.5) An original image is obtained.

(2.5) An initial binary image is obtained. The initial binary image and the original image have the same quantity of pixels, and pixel values of pixels in the initial binary image include a or b, where a and b are not equal.

(3.5) A function value of an objective function is obtained according to the original image and the initial binary image. The objective function is configured to calculate a difference between the original image and the initial binary image.

(4.10) In the process of iteratively performing the step of adjusting the pixel value of the pixel in the initial binary image once, the pixel value of current pixel is first inverted pixel by pixel.

(5.1) It is determined whether the pixel value of the current pixel and the pixel value of its neighboring pixel are the same.

Since the pixel value of the current pixel and pixel values of some neighboring pixels thereof may be the same after the pixel values of all the pixels are inverted, it is determined whether the pixel value of the current pixel and the pixel value of its neighboring pixel are the same before the swap between the pixel value of the current pixel and the pixel value of the neighboring pixel is performed.

(5.2) The pixel value of the current pixel is swapped with a pixel value of one of its neighboring pixels when the pixel value of the current pixel and the pixel values of its neighboring pixels are different.

When the pixel value of the current pixel and the pixel value of the neighboring pixel are different, it means that there is a change before and after the swap between the pixel value of the current pixel and the pixel value of the neighboring pixel, so it is determined that the swap between the pixel value of the current pixel and the pixel value of one neighboring pixel is continued, and then the function values corresponding to the initial binary image before and after the swap can be compared to minimize the function value to obtain the final binary image closest to the original image.

(6.1) The neighboring pixel of the current pixel is replaced, and step (5.2) is repeated.

(7.1) The position of the current pixel in the initial binary image is replaced, and steps (5.2) and (6.1) are repeated until all pixels in the initial binary image are traversed. After each adjustment step, steps (2.2) and (3.5) are repeated to minimize a function value until a preset iteration stop condition is met, and a result output by a latest iteration is used as a final binary image.

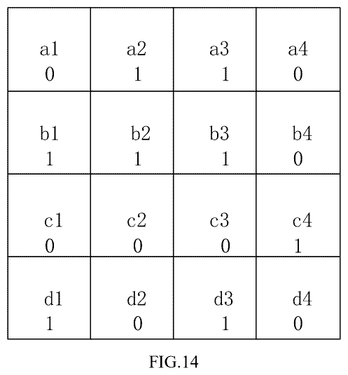

Exemplarily, with continued reference to FIG. 10, FIG. 10 is set to be an initial binary image after pixel value inversion is performed pixel by pixel, that is, pixel values of a1 to d4 are all inverted, and the pixel value swap between the current pixel and its neighboring pixels is continued. If the current pixel is a1, it is determined whether the current pixel a1 is the same as the neighboring pixel b2. If the current pixel a1 is different from the neighboring pixel b2, the pixel value of a1 is swapped with the pixel value of b2. FIG. 14 is a schematic diagram of a seventh initial binary image according to an embodiment of the present disclosure, and FIG. 14 shows an initial binary image obtained after the pixel value of a1 is swapped with the pixel value of b2.

In the technical solutions of the embodiments of the present disclosure, the comparison step is added before the current pixel is swapped with the neighboring pixel, it is determined whether the pixel value of the current pixel and the pixel value of the neighboring pixel are the same, and when the pixel value of the current pixel and the pixel value of the neighboring pixel are different, the pixel value swap of the neighboring pixel is performed, thereby further reducing the computational load.

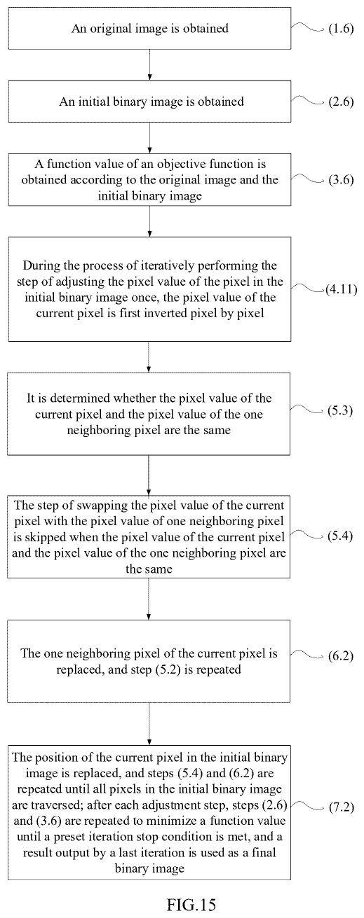

According to the above embodiments, FIG. 15 is a flowchart of a seventh display control method according to an embodiment of the present disclosure. As shown in FIG. 15, the display control method includes the following steps.

(1.6) An original image is obtained.

(2.6) An initial binary image is obtained. The initial binary image and the original image have the same quantity of pixels, and pixel values of pixels in the initial binary image include a or b, where a and b are not equal.

(3.6) A function value of an objective function is obtained according to the original image and the initial binary image. The objective function is configured to calculate a difference between the original image and the initial binary image.

(4.11) In the process of iteratively performing the step of adjusting the pixel value of the pixel in the initial binary image once, the pixel value of the current pixel is first inverted pixel by pixel.

(5.3) It is determined whether the pixel value of the current pixel and the pixel values of its neighboring pixels are the same.

(5.4) When the pixel value of the current pixel and the pixel value of the neighboring pixel are the same, A step of the swap between the pixel value of the current pixel and the pixel value of the neighboring pixel is skipped.

When the pixel value of the current pixel and the pixel value of the neighboring pixel are the same, it means that there is no change before and after the swap between the pixel value of the current pixel and the pixel value of the neighboring pixel, and there is no need to swap, and the step of the swap between the pixel value of the current pixel and the pixel value of the neighboring pixel is skipped and the determination of whether the current pixel and other neighboring pixels are the same is continued.

(6.2) The neighboring pixel of the current pixel is replaced, and step (5.4) is repeated.

(7.2) The position of the current pixel in the initial binary image is replaced, and steps (5.4) and (6.2) are repeated until all pixels in the initial binary image are traversed. After each adjustment step, steps (2.6) and (3.6) are repeated to minimize a function value until a preset iteration stop condition is met, and a result output by a latest iteration is used as a final binary image.

Exemplarily, with continued reference to FIG. 10, FIG. 10 is set to be an initial binary image after pixel value inversion is performed pixel by pixel, that is, pixel values of a1 to d4 are all inverted, and the pixel value swap between the current pixel and its neighboring pixels is continued. If the current pixel is set as a1, it is determined whether the current pixel a1 is the same as the neighboring pixel a2. If the pixel value of the current pixel a1 and the pixel value of the neighboring pixel a2 are both the same as 1, then the step of swapping the pixel value of a1 with the pixel value of a2 is skipped, and it is further determined whether the pixel value of a1 and the pixel value of b2 are the same.

In the technical solutions of the embodiments of the present disclosure, the comparison step is added before the current pixel is swapped with the neighboring pixel, it is determined whether the pixel value of the current pixel and the pixel value of the neighboring pixel are the same, and when the pixel value of the current pixel and the pixel value of the neighboring pixel are the same, no swapping step is performed and the process after swapping step is not performed, thereby further reducing the computational load.

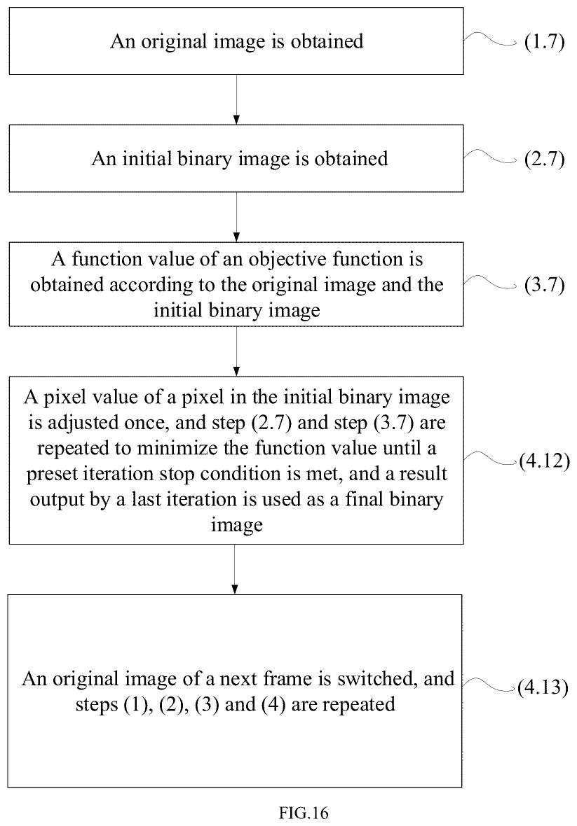

According to the above embodiments, FIG. 16 is a flowchart of an eighth display control method according to an embodiment of the present disclosure. As shown in FIG. 16, the display control method includes the following steps.

(1.7) An original image is obtained.

(2.7) An initial binary image is obtained. The initial binary image and the original image have the same quantity of pixels, and pixel values of pixels in the initial binary image include a or b, where a and b are not equal.

(3.7) A function value of an objective function is obtained according to the original image and the initial binary image. The objective function is configured to calculate a difference between the original image and the initial binary image.

(4.12) The pixel value of the pixel in the initial binary image are adjusted once, and step (2.7) and step (3.7) are repeated to minimize the function value until a preset iteration stop condition is met, and a result output by a latest iteration is used as a final binary image.

(4.13) An original image of a next frame is switched, and steps (1), (2), (3) and (4) are repeated.

The original image of the next frame may be an image of the next frame in the to-be-processed video.

In some embodiments, in order to ensure the processing efficiency of the to-be-processed video, frame decomposition of the to-be-processed video and the original image acquisition may be performed synchronously, that is, each time the to-be-processed video is decomposed into an original image of one frame, in the display control method, the original image of the one frame is obtained and processed to output a corresponding final binary image, and then an original image of the next frame is received, so as to ensure the processing efficiency of the to-be-processed video.

In some embodiments, the final binary image of the current frame is configured as the initial binary image of the next frame. Since the final binary image with the minimum difference from the original image needs to be continuously calculated after the original image of the next frame is switched, and the pixel value change between the original images of consecutive frames is relatively small, when the initial binary image is obtained, the final binary image of the previous frame is configured as the initial binary image of the next frame, which can reduce the difference between the final binary images corresponding to the adjacent frames, enhance the relationship between the final binary images of the adjacent frames, and thus improving the quality of the processed video.

In an embodiment, after the final binary image of original image of the first frame is obtained, the original image of next frame continues to be processed, and the final binary image of the original image of next frame is obtained until the original images of all frames decomposed from the to-be-processed video are processed, so as to output the processed halftone video.

It can be understood that, due to the accumulation of algorithm errors, the error diffusion algorithm in the related art may cause serious texture changes even if there is only a slight change in the original adjacent frame images, further resulting in severe visual flickering. For example, the first frame image and the second frame image, both with a resolution of 4*4, where pixel values of 8 pixels are 0 and pixel values of the other 8 pixels are 1, are processed respectively, even if the same grayscale is simulated, there are many processing manners with different pixel arrangement manners. As the video frames are switched, the pixel value at the same pixel position is changed, and the visual flickering is formed. However, in the technical solutions of the embodiments of the present disclosure, the final binary image of the current frame is configured as the initial binary image of the next frame, the pixel position relationship between the final binary image of the previous frame and the initial binary image of the next frame is constructed. When the final binary image of the current frame is adjusted in combination with the original image of the next frame, since only the pixel values of fewer pixels change, the pixel values of most pixels remain the same as those of the previous frame, so that there is no flickering phenomenon when the processed video is switched between frames, thereby improving the single-frame quality of the video and improving the overall quality of the video.

In the technical solutions of the embodiments of the present disclosure, the original image of next frame is continuously obtained after the final binary image of the current original image is output, and the original image of next frame is continuously processed, thereby ensuring the processing efficiency of the to-be-processed video. In addition, by replacing the initial binary image of the next frame with the obtained final binary image of the previous frame, the difference between the final binary images corresponding to adjacent frames is reduced, thereby enhancing the linkage between the final binary images of the adjacent frames, eliminating the flickering problem, and thus improving the quality of the processed video.

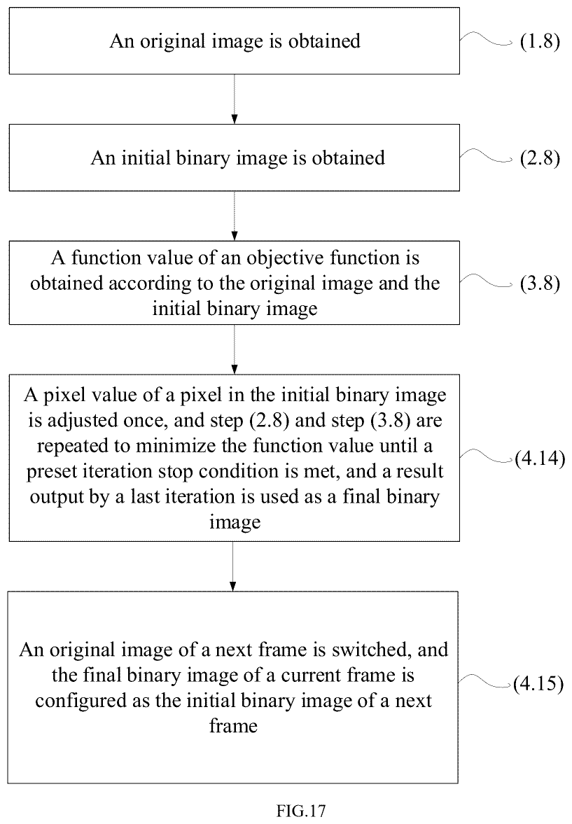

According to the above embodiments, FIG. 17 is a flowchart of a ninth display control method according to an embodiment of the present disclosure. As shown in FIG. 17, the display control method includes the following steps.

(1.9) An original image is obtained.

(2.9) An initial binary image is obtained. The initial binary image and the original image have the same quantity of pixels, and pixel values of pixels in the initial binary image include a or b, where a and b are not equal.

(3.9) The original image and the initial binary image are low-pass filtered.

The purpose of performing low-pass filtering on the original image and the initial binary image may be to simulate a low-pass filtering effect of human eyes. Low-pass filtering of human eyes refers to the ability of the human eyes to perform low-pass filtering on high-frequency signals. Therefore, at normal observation distances, after the initial binary image and the original image are mixed visually, other grayscale values besides black and white can be presented.

The low-pass filtering performed on the original image and the initial binary image may be implemented by using a filtering model. The filtering model needs to have characteristics of low-pass filtering, such as low-pass Gaussian filtering, so that the original image and the initial binary image after low-pass filtering are reduced in sharpening, thereby making edges smoother, reducing a visual difference between the original image and the initial binary image, and thus improving the quality of the intra-frame image.

(3.10) The function value of the objective function is obtained according to the original image and the initial binary image. The objective function is configured to calculate a difference between the original image and the initial binary image.

(4.16) The pixel values of the pixel in the initial binary image is adjusted once, and step (2.9) and step (3.10) are repeated to minimize the function value until a preset iteration stop condition is met, and a result output by a latest iteration is used as a final binary image.

It may be understood that after the original image and the initial binary image are obtained each time, low-pass filtering needs to be performed on the original image and the initial binary image, and then a corresponding function value is obtained. The times of low-pass filtering performed on the original image and the initial binary image should be consistent. For example, only low-pass filtering and convolution processing are performed on the original image, and no convolution processing is performed on the initial binary image, the original image and the initial binary image differ from each other by one convolution processing process, which cannot achieve the effect of reducing the visual difference between the original image and the initial binary image.

In the technical solutions of the embodiments of the present disclosure, the original image and the initial binary image are subjected to low-pass filtering processing before the objective function value of the original image and the initial binary image is obtained, so that the low-pass filtered original image and the initial binary image can simulate the effect of low-pass filtering of human eyes, thereby reducing the visual difference between the original image and the initial binary image, and thus improving the quality of intra-frame images.

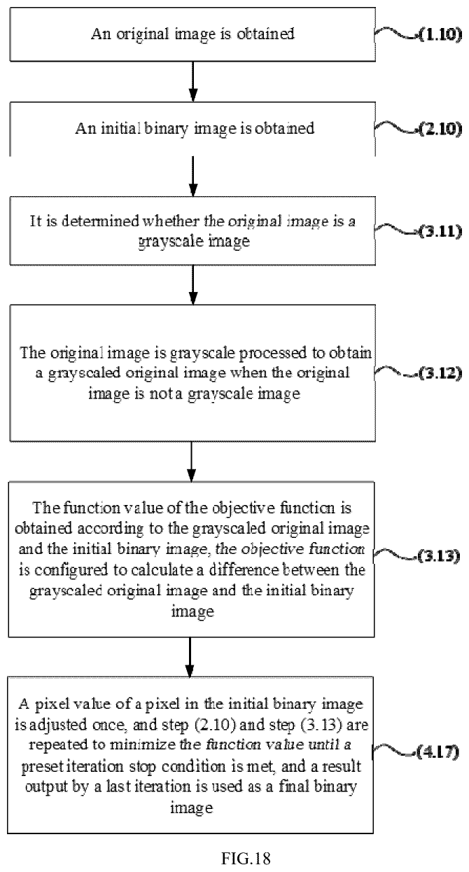

According to the above embodiments, FIG. 18 is a flowchart of a tenth display control method according to an embodiment of the present disclosure. As shown in FIG. 18, the display control method includes the following steps.

(1.10) An original image is obtained.

(2.10) An initial binary image is obtained. The initial binary image and the original image have the same quantity of pixels, and pixel values of pixels in the initial binary image include a or b, where a and b are not equal.

(3.11) It is determined whether the original image is a grayscale image.

(3.12) The original image is grayscale processed to obtain a grayscaled original image when the original image is not a grayscale image.

The grayscale image may be an image in which the grayscale values of pixels are within the range of 0 to 255, including only brightness information and not color information. The grayscale processing can convert a color image into a grayscale image.

(3.13) The function value of the objective function is obtained according to the grayscaled original image and the initial binary image. The objective function is configured to calculate a difference between the grayscaled original image and the initial binary image.

Because the initial binary image may be an image with pixel values only including 0 or 1, and the processing objective of the to-be-processed video is to obtain a halftone video, after obtaining the original image, it is determined whether the original image is a grayscale image, and when the original image is not a grayscale image, grayscale processing is performed on the original image, so that the initial binary image may be compared and adjusted with the grayscaled original image.

(4.17) The pixel value of the pixel in the initial binary image is adjusted once, and step (2.10) and step (3.13) are repeated to minimize the function value until a preset iteration stop condition is met, and a result output by a latest iteration is used as a final binary image.

In an embodiment, after the original image is obtained, it is determined whether the original image is a grayscale image, that is, it is determined whether the original image is a color image. When the original image is a color image, it means that the original image is not a grayscale image. The original image is grayscale processed, and after processing the pixel value of each pixel in the original image to a grayscale value within the range of 0 to 255, the function value of the objective function is obtained.

In the technical solutions of the embodiments of the present disclosure, it is determined whether the original image is a grayscale image after the original image is obtained, and when it is not a grayscale image, grayscale processing is performed on the original image, so that the initial binary image can be compared and adjusted with the grayscaled original image, ensuring the normal operation of the display control method.

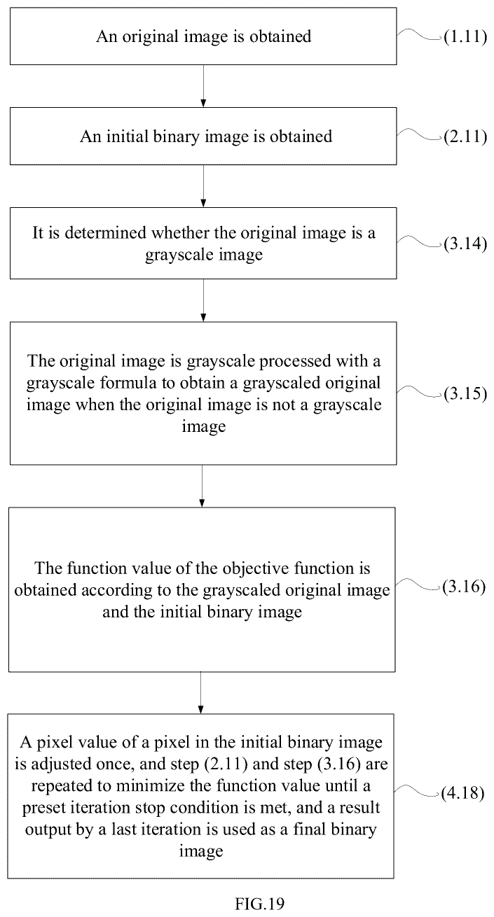

According to the above embodiments, FIG. 19 is a flowchart of an eleventh display control method according to an embodiment of the present disclosure. As shown in FIG. 19, the display control method includes the following steps.

(1.11) An original image is obtained.

(2.11) An initial binary image is obtained. The initial binary image and the original image have the same quantity of pixels, and pixel values of pixels in the initial binary image include a or b, where a and b are not equal.

(3.14) It is determined whether the original image is a grayscale image.

(3.15) When the original image is not a grayscale image, the original image is grayscale processed with a grayscale formula to obtain a grayscaled original image.

The grayscale formula satisfies: Gray=0.299R+0.587G+0.114B.

Gray is a pixel value of a pixel in the grayscaled original image, R is a value of a [symbol] channel of a pixel in an original image before grayscale processing, G is a value of a green color channel of a pixel in an original image before grayscale processing, and B is a value of a blue color channel of a pixel in an original image before grayscale processing.

Since the pixels of the color image are formed by mixing three primary colors of [symbol] values of the red color channel, the green color channel and the blue color channel in the same pixel are different, that is, the RGB ratios are different, resulting in different colors of the pixels. The value R of the red color channel, the value G of the green color channel, and the value B of the blue color channel for each pixel in the original image are obtained, and the grayscale formula Gray=0.299R+0.587G+0.114B is used to perform grayscale processing on each pixel in the original image to obtain the processed original image.

(3.16) The function value of the objective function is obtained according to the grayscaled original image and the initial binary image. The objective function is configured to calculate a difference between the grayscaled original image and the initial binary image.

(4.18) The pixel value of the pixel in the initial binary image is adjusted once, and step (2.11) and step (3.16) are repeated to minimize the function value until a preset iteration stop condition is met, and a result output by a latest iteration is used as a final binary image.

In the technical solutions of the embodiments of the present disclosure, by using the grayscale formula to perform grayscale processing on the original image, the acquisition of the grayscaled original image is ensured, so that the initial binary image can be compared and adjusted with the grayscaled original image.

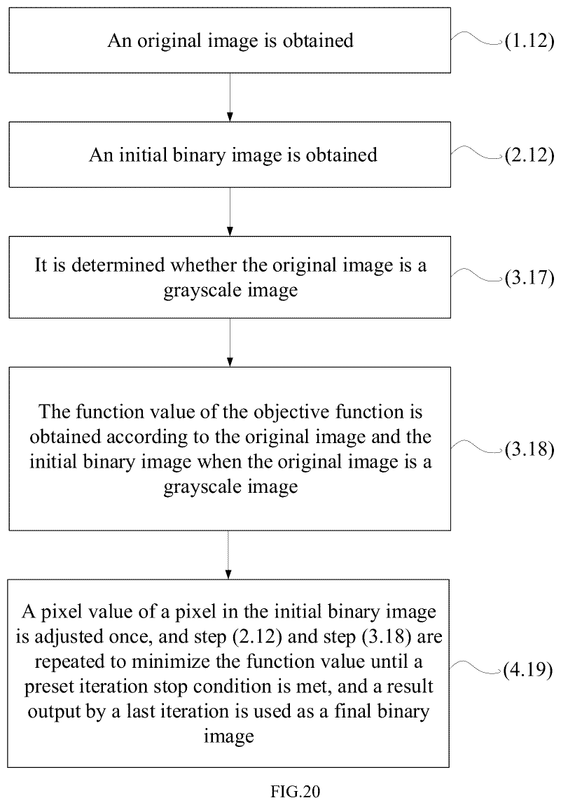

According to the above embodiments, FIG. 20 is a flowchart of a twelfth display control method according to an embodiment of the present disclosure. As shown in FIG. 20, the display control method includes the following steps.

(1.12) An original image is obtained.

(2.12) An initial binary image is obtained. The initial binary image and the original image have the same quantity of pixels, and pixel values of pixels in the initial binary image include a or b, where a and b are not equal.

(3.17) It is determined whether the original image is a grayscale image.

(3.18) A function value of an objective function is obtained according to the original image and the initial binary image when the original image is a grayscale image. The objective function is configured to calculate a difference between the original image and the initial binary image.

When the original image is a grayscale image, there is no need to perform grayscale processing on the original image, so that the comparison and adjustment of the function values can be carried out only based on the original image and the initial binary image, and at this time, the function value of the objective function corresponding to the original image and the initial binary image are directly obtained without the step of grayscale processing of the original image.

(4.19) The pixel value of the pixel in the initial binary image is adjusted once, and step (2.12) and step (3.18) are repeated to minimize the function value until a preset iteration stop condition is met, and a result output by a latest iteration is used as a final binary image.

In the technical solutions of the embodiments of the present disclosure, it is determined whether the original image is the grayscale image after the original image is obtained, and the step of grayscale processing of the original image is skipped after the original image is the grayscale image, ensuring that the function value of the initial binary image can be compared and adjusted with that of the grayscale original image while reducing the computational load and improving processing efficiency.

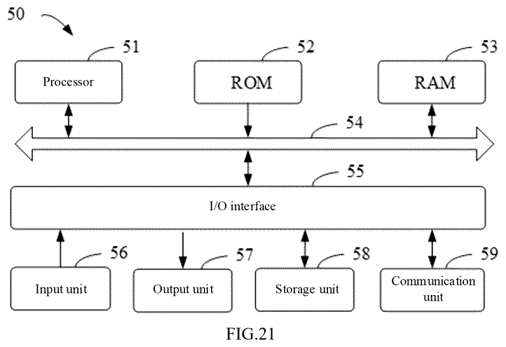

Based on the same inventive concept, an embodiment of the present disclosure further provides an electronic device, and FIG. 21 is a structural diagram of an electronic device applied to a display control method according to the embodiments of the present disclosure. As shown in FIG. 21, the electronic device includes a memory, a processor, and a computer program stored on the memory and executable on the processor. The display control method is implemented when the processor executes the program.

Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices (such as helmets, glasses, watches), and other similar computing devices. The components, their connections and relationships, and their functions shown herein are only examples and are not intended to limit the implementations of the present disclosure described and/or claimed herein.

As shown in FIG. 21, the electronic device 50 includes at least one processor 51, and a memory communicatively connected to the at least one processor 51, such as a read-only memory (ROM) 52 and a random access memory (RAM) 53. The memory stores a computer program executable by the at least one processor. The processor 51 may perform various appropriate actions and processing according to the computer program stored in the read-only memory (ROM) 52 or the computer program loaded from the storage unit 58 into the random access memory (RAM) 53. In the RAM 53, various programs and data required for the operation of the electronic device 50 may also be stored. The processor 51, the ROM 52, and the RAM 53 are connected to each other through a bus 54. An input/output (I/O) interface 55 is also connected to the bus 54.

The plurality of components in the electronic device 50 are connected to the I/O interface 55, including: an input unit 56, such as a keyboard, a mouse; an output unit 57, such as various types of displays, speakers; a storage unit 58, such as a magnetic disk, an optical disk; and a communication unit 59, such as a network card, a modem, a wireless communication transceiver. The communication unit 59 allows the electronic device 50 to exchange information/data with other devices through a computer network such as the Internet and/or various telecommunication networks.

The processor 51 may be various general-purpose and/or specialized processing components having processing and computing capabilities. Some examples of the processor 51 include, but are not limited to, central processing units (CPUs), graphics processing units (GPUs), various specialized artificial intelligence (AI) computing chips, various processors running machine learning model algorithms, digital signal processors (DSPs), and any suitable processors, controllers, microcontrollers. The processor 51 performs various methods and processing described above, for example, applied to a display control method.

Based on the same inventive concept, an embodiment of the present disclosure further provides a computer readable storage medium. The program, when executed by a processor, implements the display control method.

Certainly, in the computer-readable storage medium provided in an embodiment of the present disclosure, the computer-executable instructions thereof are not limited to the method operations described above, and related operations in the display control method provided in any embodiment of the present disclosure may also be performed. Continuing to refer to FIG. 21, it tangibly includes the computer-readable storage medium, such as the storage unit 58. In some embodiments, part or all of the computer program may be loaded and/or installed on the electronic device 50 via the ROM 52 and/or the communication unit 59. When the computer program is loaded into the RAM 53 and executed by the processor 51, one or more steps described above in the display control method may be performed. Alternatively, in other embodiments, the processor 51 may be configured to execute the display control method in any other suitable manner (for example, by means of firmware).

Various implementations of the systems and techniques described above herein may be implemented in digital electronic circuit systems, integrated circuit systems, field programmable gate arrays (FPGAs), application specific integrated circuits (ASICs), application specific standard products (ASSPs), systems on a chip (SOCs), load programmable logic devices (CPLDs), computer hardware, firmware, software, and/or combinations thereof. These various implementation methods may include: being implemented in one or more computer programs, the one or more computer programs being executable and/or interpretable on a programmable system including at least one programmable processor, which may be a dedicated or general-purpose programmable processor; receiving data and instructions from a storage system, at least one input device, and at least one output device; and transmitting the data and instructions to the storage system, the at least one input device and the at least one output device.

Computer programs for implementing the methods of the present disclosure may be written in any combination of one or more programming languages. These computer programs may be provided to a processor of a general purpose computer, specialized computer, or other programmable data processing apparatus, such that the computer programs, when executed by the processor, enable the functions/operations specified in the flowchart and/or block diagram to be implemented. The computer program may be executed entirely on the machine, partially on the machine, partially on the machine as an independent software package and partially on a remote machine or entirely on a remote machine or a server.

In the context of embodiments of the present disclosure, a computer-readable storage medium may be a tangible medium that may contain or store a computer program for use by or in connection with an instruction execution system, an apparatus, or a device. The computer-readable storage medium may be, for example, but not limited to, an electrical, magnetic, optical, electromagnetic, infrared, or semiconductor system, apparatus, or device, or any combination thereof. Alternatively, the computer-readable storage medium may be a machine-readable signal medium. More specific examples of the computer-readable storage media include: an electrical connection based on one or more wires, a portable computer disk, a hard disk, a random access memory (RAM), and a read only memory (ROM), an erasable programmable read only memory (EPROM or a flash memory), an optical fiber, a portable compact disk read only memory (CD-ROM), an optical storage device, a magnetic storage device, or any suitable combination of the above devices.

It should be understood that various forms of processes shown above may be used to reorder, add or delete steps. For example, the steps described in the present disclosure may be performed in parallel or sequentially, or may be performed in a different order, as long as a desired result of the technical solutions of the present disclosure can be implemented, which is not limited herein.

The above embodiments do not limit the protection scope of the present disclosure. Those skilled in the art should understand that various modifications, combinations, sub-combinations, and substitutions can be made according to design requirements and other factors. Any modifications, equivalent substitutions and improvements made within the spirit and principle of the present disclosure shall fall within the protection scope of the present disclosure.

What is claimed is:

1. A display control method, comprising:
(1) obtaining an original image;
(2) obtaining an initial binary image, wherein the initial binary image and the original image have the same quantity of pixels, and pixel values of pixels in the initial binary image comprise a or b, wherein a and b are not equal;
(3) obtaining a function value of an objective function based on the original image and the initial binary image, wherein the objective function is configured to calculate a difference between the original image and the initial binary image; and
(4) adjusting a pixel value of a pixel in the initial binary image once, repeating step (2) and step (3) to minimize the function value until a preset iteration stop condition is met, and using a result output by a latest iteration as a final binary image.

2. The display control method according to claim 1, wherein the objective function comprises a calculation of a structural similarity between the original image and the initial binary image.

3. The display control method according to claim 2, wherein the objective function satisfies:
$$\frac{( 2 μ {}_{G} {μ}_{H} + {C}_{1} ) ( 2 {σ}_{GH} + {C}_{2} )}{( {{μ}_{G}}^{2} + {{μ}_{H}}^{2} + {C}_{1} ) ( {σ}_{G} + {σ}_{H} + {C}_{2} )} ;$$ [symbol]
ein uG is a mean value of the original image, μ_{H} is a mean value of the initial binary is a variance of the original image, σ_{H} is a variance of the initial binary image, and σ_{GH} is a covariance between the original image and the initial binary image;
(K₁L)²;
(K₂L)²; [symbol]
ein K₁ and K₂ are constants not exceeding 0.1, and L is an image grayscale dynamic [symbol] e display control method according to claim 3, wherein K₁ is 0.01 and K₂ is 0.02.

5. The display control method according to claim 2, wherein the objective function further satisfies:
$$′ {f}_{1} + ( 1 - γ ) {f}_{2} ;$$ [symbol]
ein ƒ₂ is configured to calculate an error between the original image and the initial [symbol] ige, γ is a constant greater than or equal to 0 and less than or equal to 1.

6. The display control method according to claim 5, wherein the objective function further satisfies:
Σ|G(x,y)−H(x,y)|²; [symbol]
ein G(x,y) is a pixel value of a pixel at the row x and column y in the original [symbol] (x,y) is a pixel value of a pixel at the row x and column y in the initial binary image.

7. The display control method according to claim 1, before step (4), further comprising:
determining whether a function value in a current iteration is less than a function value in a previous iteration;
wherein the adjusting a pixel value of a pixel in the initial binary image once comprises:
when the function value in the current iteration is less than the function value in the previous iteration, adjusting the pixel value of the pixel in the initial binary image once by using the initial binary image in the current iteration as an iteration output result in the current iteration.

8. The display control method according to claim 7, wherein the adjusting a pixel value of a pixel in the initial binary image once further comprises:
when the function value in the current iteration is greater than or equal to the function value in the previous iteration, adjusting the pixel value of the pixel in the initial binary image once by using the initial binary image in the previous iteration as an iteration output result in the current iteration.

9. The display control method according to claim 1, wherein step (4) comprises:
during the process of iteratively performing the step of adjusting the pixel value of the pixel in the initial binary image once, first inverting a pixel value of a current pixel for each pixel one by one, and then swapping the pixel value of the current pixel with pixel values of neighboring pixels for each pixel one by one.

10. The display control method according to claim 9, wherein swapping the pixel value of the current pixel with pixel values of neighboring pixels for each pixel one by one comprises:
(5) swapping the pixel value of the current pixel with a pixel value of one neighboring pixel of the neighboring pixels;
(6) replacing the one neighboring pixel of the current pixel with another one neighboring pixel of the neighboring pixels, and repeating step (5); and
(7) replacing a position of the current pixel in the initial binary image, and repeating steps (5) and (6) until all pixels in the initial binary image are traversed.

11. The display control method according to claim 10, wherein before swapping the pixel value of the current pixel with a pixel value of one neighboring pixel of the neighboring pixels, the method further comprises:
determining whether the pixel value of the current pixel and the pixel value of the one neighboring pixel are the same;
wherein swapping the pixel value of the current pixel with a pixel value of one neighboring pixel of the neighboring pixels, comprises:
swapping the pixel value of the current pixel with the pixel value of the one neighboring pixel when the pixel value of the current pixel and the pixel value of the one neighboring pixel are different.

12. The display control method according to claim 10, wherein before swapping the pixel value of the current pixel with a pixel value of one neighboring pixel of the neighboring pixels, the method further comprises:
determining whether the pixel value of the current pixel and the pixel value of the one neighboring pixel are the same;
skipping a step of swapping the pixel value of the current pixel with the pixel value of the one neighboring pixel when the pixel value of the current pixel and the pixel value of the one neighboring pixel are the same.

13. The display control method according to claim 1, after step (4), further comprising:
switching to an original image of a next frame, and repeating steps (1), (2), (3) and (4).

14. The display control method according to claim 13, wherein the final binary image of a current frame is configured as the initial binary image of a next frame.

15. The display control method according to claim 1, before step (3), further comprising:
performing low-pass filtering on the original image and the initial binary image.

16. The display control method according to claim 1, before step (3), further comprising:
determining whether the original image is a grayscale image;
performing grayscale processing on the original image to obtain a grayscaled original image when the original image is not a grayscale image;
wherein step (3) comprises:
obtaining the function value of the objective function based on the grayscaled original image and the initial binary image, wherein the objective function is configured to calculate a difference between the grayscaled original image and the initial binary image.

17. The display control method according to claim 16, wherein performing grayscale processing on the original image to obtain a grayscaled original image comprises:
performing grayscale processing on the original image by using a grayscale formula to obtain a grayscaled original image;
wherein the grayscale formula satisfies:
$$= 0.299 R + 0.587 G + 0.114 B ;$$ [symbol]
ein Gray is a pixel value of a pixel in the grayscaled original image, R is a value of a [symbol] hannel of a pixel in the original image before grayscale processing, G is a value of a green color channel of a pixel in the original image before grayscale processing, and B is a value of a blue color channel of a pixel in the original image before grayscale processing.

18. The display control method according to claim 1, before step (3), further comprising:
determining whether the original image is a grayscale image;
wherein step (3) comprises:
obtaining the function value of the objective function based on the original image and the initial binary image when the original image is a grayscale image, wherein the objective function is configured to calculate the difference between the original image and the initial binary image.

19. An electronic device, comprising a memory, a processor, and a computer program stored in the memory and executable on the processor, wherein the processor implements a display control method comprising:
(1) obtaining an original image;
(2) obtaining an initial binary image, wherein the initial binary image and the original image have the same quantity of pixels, and pixel values of pixels in the initial binary image comprise a or b, wherein a and b are not equal;
(3) obtaining a function value of an objective function based on the original image and the initial binary image, wherein the objective function is configured to calculate a difference between the original image and the initial binary image; and
(4) adjusting a pixel value of a pixel in the initial binary image once, repeating step (2) and step (3) to minimize the function value until a preset iteration stop condition is met, and using a result output by a latest iteration as a final binary image.

20. A computer readable storage medium storing a computer program, wherein the program, when executed by a processor, implements a display control method comprising:
(1) obtaining an original image;
(2) obtaining an initial binary image, wherein the initial binary image and the original image have the same quantity of pixels, and pixel values of pixels in the initial binary image comprise a or b, wherein a and b are not equal;
(3) obtaining a function value of an objective function based on the original image and the initial binary image, wherein the objective function is configured to calculate a difference between the original image and the initial binary image; and
(4) adjusting a pixel value of a pixel in the initial binary image once, repeating step (2) and step (3) to minimize the function value until a preset iteration stop condition is met, and using a result output by a latest iteration as a final binary image.
